(19) United States
(12) Patent Application Publication
(10) Pub. No.: US 2016/0259842 A1
(43) Pub. Date: Sep. 8, 2016

(54) SYSTEM AND METHOD FOR CATEGORIZING EVENTS

(71) Applicant: GE Aviation Systems Limited, Cheltenham Gloucestershire (GB)

(72) Inventors: Peter Robin KNIGHT, Eastleigh, Hampshire (GB); Olivier Paul Jacques Thanh Minh THUONG, Eastleigh, Hampshire (GB); Hatice Mujde AYIK, Istanbul (TR)

(21) Appl. No.: 15/031,481

(22) PCT Filed: Oct. 23, 2013
(86) PCT No.: PCT/EP2013/072207

§ 371 Date: Apr. 22, 2016

(51) Int. Cl. G06F 17/30; G06N 99/00

(52) U.S. Cl. CPC G06F 17/30598; G06F 17/30528; G06N 99/005

(57) ABSTRACT

A system for categorizing events found in data including a computer searchable database containing unlabeled data related to one or more systems or assets and data related to reported events and a classifier module in communication with the database and configured to: receive data from the database, select from the unlabeled data and event related to the reported events, and classify the selected event based thereon.

### CROSS-REFERENCE TO RELATED APPLICATIONS

This application is a national stage application under 35 U.S.C. §371(c) of prior filed, co-pending PCT application serial number PCT/EP2013/072207, filed on Oct. 23, 2013, titled “SYSTEM AND METHOD FOR CATEGORIZING EVENTS”. The above-listed application is herein incorporated by reference.

### BACKGROUND

Contemporary systems may output large quantities of data. Such systems may vary widely and may include a variety of data. For example, such systems may include aircraft health data, financial data, or data from healthcare systems. When monitoring such complex systems, large quantities of data are generated and may hinder the understanding of events in the system.

### BRIEF DESCRIPTION

In one aspect, an embodiment of the innovation relates to a method of categorizing events found in data including receiving data related to one or more systems or assets from the one or more systems or assets, receiving data regarding reported events, selecting an event from the data related to the one or more systems or assets based on the data regarding the reported events, and labeling the selected event.

In another aspect, an embodiment of the innovation relates to a system for categorizing events including a computer-searchable database containing data related to one or more systems or assets and data related to reported events and a labeling module in communication with the database and configured to: receive data from the database, select from the data an event related to the reported events table, and label the event based thereon.

### BRIEF DESCRIPTION OF THE DRAWINGS

In the drawings:

FIG. 1 is a schematic illustration of the information that may be used in a method of categorizing events according to various aspects described herein.

FIG. 2 is a schematic illustration of an exemplary system.

FIG. 3 is a flowchart showing a method of categorizing events according to various aspects described herein.

FIG. 4 is a flowchart similar to the flowchart of FIG. 3 and illustrating additional determinations.

FIG. 5 is an exemplary display for obtaining a user validation or selection and illustrating an incorrect selection.

FIG. 6 is another exemplary display similar to FIG. 5 with a corrected selection.

### DETAILED DESCRIPTION

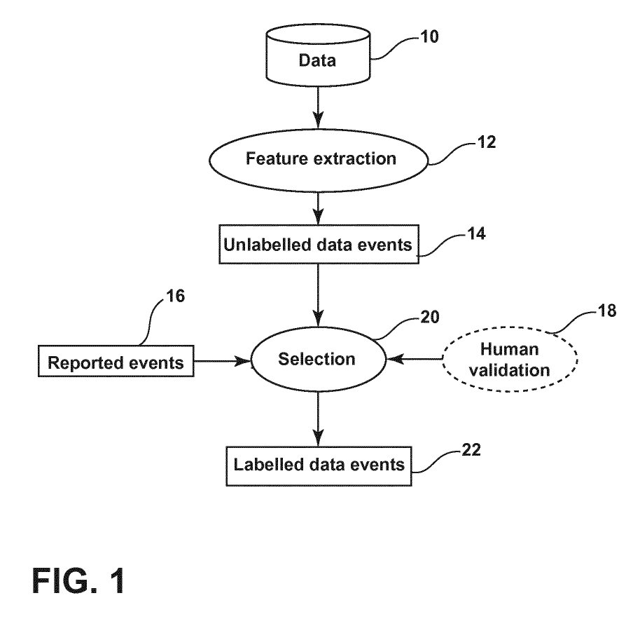

An initial pictorial explanation of an embodiment of the innovation may prove useful. FIG. 1 schematically illustrates information that may be used in a method of categorizing events according to an embodiment of the innovation as well as selections that may be made and information that may be output based thereon. More specifically, initial data 10 is illustrated as being provided. It will be understood that such initial data 10 may be any amount of data from any suitable system or asset for which information may be collected and monitored for any given reason including for monitoring the health of the system. By way of non-limiting example, the initial data 10 may include by way of non-limiting examples all or a portion of all of the data received from an aircraft or an aircraft engine, a power plant, a train, a ship engine, etc. Furthermore, the initial data 10 may pertain to financial data or data from healthcare systems. The initial data 10 may include raw data or refined data related to the system or asset. Further, the initial data 10 may be provided as a stream of data and such a stream may be intermittent or continuous.

It is contemplated that feature extraction at 12 may be used to process the initial data 10. This may be done in any suitable manner including by a general-purpose computer running feature extraction algorithms. For example, the initial data 10 may be processed in some way to derive features that make the component health of the system or asset stand out. In this manner, the initial data 10 may be processed in such a way that it provides useful information, which is indicative of a notable event. The processed data may be thought of as unlabeled data information or unlabeled data events 14. Such unlabeled data events 14 along with reported events 16 may be processed and a selection 20 may be made based thereon. More specifically, an event may be selected from the unlabeled data events 14 based on the reported events 16. The selection 20 may also optionally take into consideration human validation 18, although this need not be the case. The selection 20 may also be performed in any suitable manner including by a general-purpose computer running a selection algorithm. Based on the selection 20 labeled data events 22 may be created. In this manner, the unlabeled data events 14 may be categorized into labeled data events 22.

Such labeled data events 22 may then be used for a variety of purposes. For example, classifiers must be trained in a supervised manner, which means that it is necessary to have a labeled dataset available, i.e. a list of events, with their features, labeled with the nature of the event. Thus, the labeled data events 22 may be used for classifier training and/or classifier testing. Such a classifier may be understood to be a model that performs statistical classification; more specifically such a model may identify to which set of categories a new observation belongs, on the basis of a training set of data containing observations whose category membership is known.

In this manner, the health of a fleet of assets may be monitored by continuously watching performance data and detecting events such as shifts or trends in performance indicators. When an event is detected, the embodiments of the innovation may determine the actual nature of the event such as whether it is a fault, which type of fault, or which severity, from the features of the event and from a list of reported events. Using this information to label the dataset in an automated way may be a challenge because the dates where the faults were detected or confirmed may not, in general, match the date where the event could be observed in the data. The embodiments of the innovation automatically or semi-automatically select data events that are the most likely to be related to each reported event and if necessary allow a user to confirm those matches in a quick and efficient way.

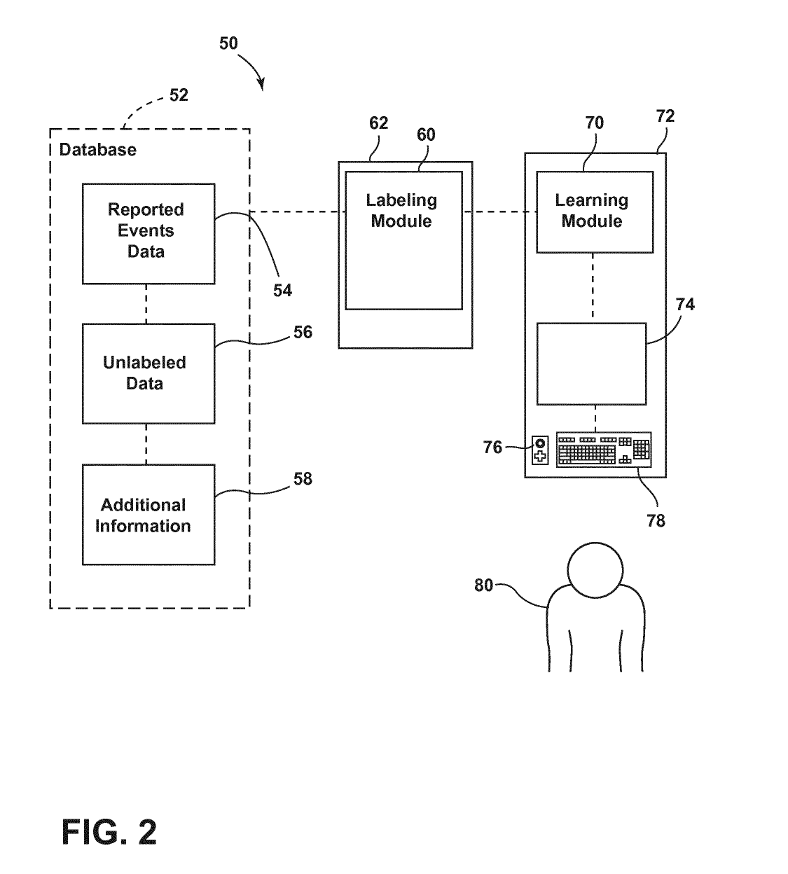

By way of non-limiting example, a system 50 for categorizing events has been illustrated in FIG. 2 as including a computer-searchable database 52, a labeling module 60, and a learning module 70. Details of the system 50 are set forth in order to provide a thorough understanding of the technology described herein. It will be evident to one skilled in the art, however, that the exemplary embodiments may be practiced without these specific details. The exemplary embodiments are described with reference to the drawings. These drawings illustrate certain details of specific embodiments that implement a module or method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system.

As noted above, embodiments described herein may include a computer program product comprising machine-readable media for carrying or having machine-executable instructions or data structures stored thereon. Such machine-readable media may be any available media, which may be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that can be used to carry or store desired program code in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data, which cause a general-purpose computer, special purpose computer, or special purpose processing machines to perform a certain function or group of functions.

Embodiments will be described in the general context of method steps that may be implemented in one embodiment by a program product including machine-executable instructions, such as program codes, for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

An exemplary system for implementing the overall or portions of the exemplary embodiments might include a general purpose computing device in the form of a computer, including a processing unit, a system memory, and a system bus, that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

It will be understood that the computer-searchable database 52 may be any suitable database, including a single database having multiple sets of data, multiple discrete databases linked together, or even simple tables of data. Regardless of the type of database, the computer-searchable database 52 may be provided on storage medium on a computer (not shown) or may be provided on a computer readable medium, such as a database server. It is contemplated that the computer-searchable database 52 may include data to be categorized and data that may aid in categorizing the uncategorized data. Such data may be received by the computer-searchable database 52 in any suitable manner. By way of non-limiting examples, such computer-searchable database 52 may include among other information data regarding reported events 54 and unlabeled data related to one or more systems or assets 56. It is contemplated that the computer-searchable database 52 may include additional information or additional data 58, such as data to aid in categorizing the data. It is further contemplated that such additional data 58 may include initial data as discussed above.

The labeling module 60 may be executed on a computer 62 configured to access or query the computer-searchable database 52 and classify selected events. It will be understood that the labeling module 60 may access the computer-searchable database 52 via a communication network or computer network coupling the labeling module 60 to the computer-searchable database 52. By way of non-limiting example, such a computer network may be a local area network or a larger network such as the internet. It is contemplated that the labeling module 60 may make repeated queries of the computer-searchable database 52. The labeling module 60 may be configured, for each of the reported events, to determine from the unlabeled events information which is the most likely to be related to a reported event. In implementation, such a selection process may be converted to an algorithm to correlate the unlabeled events and the reported events. Such an algorithm may be converted to a computer program comprising a set of executable instructions, which may be executed by the labeling module 60. Additional inputs to the computer program may include inputs from the computer-searchable database 52 and the learning module 70. The computer program may have an executable instruction set for receiving or querying data from the computer-searchable database 52, selecting from the at least one data table an event related to the reported events table, and labeling the event based thereon.

The learning module 70 may be executed on a computer 72 configured to communicate with the labeling module 60. The learning module 70 and/or the computer 72 may also be configured to communicate with the computer-searchable database 52. The learning module 70 may have a display 74 capable of presenting the selections made by the labeling module 60 to a user 80 for verification. Further, the learning module 70 may present alternative selections for a user to select from. The display 74 may be any suitable display for displaying information, verification methods, and alternative selections to the user 80. Although the display 74 has been illustrated and described as being included within the computer 72, it is contemplated that the display may be a separate device operably coupled to the learning module 70.

The learning module 70 may also have or be operably coupled to one or more cursor control devices 76 and one or more multifunction keyboards 78, which the user 80 may use to interact with the learning module 70 and the display 74. A suitable cursor control device 76 may include any device suitable to accept input from the user 80 and to convert that input to a graphical position on the display of the learning module 70. Various joysticks, multi-way rocker switches, mice, trackballs, and the like are suitable for this purpose. Although the labeling module 60 and learning module 70 have been illustrated separately, it is contemplated that they may be included in a single device. The learning module 70 may also provide the input made by the user 80 to the labeling module 60 and the inputs may be used by the labeling module 60 in its classification of the selected event.

During operation, the labeling module 60 may communicate with the computer-searchable database 52 and may receive data from the computer-searchable database 52 including unlabeled data and reported events data. The labeling module 60 may select an event from the unlabeled data that relates to a specific event in the reported events table, and the labeling module 60 may label the event based thereon.

The labeling module 60 may also determine a confidence in a relationship between the selected event and the reported events. For example, an algorithm may be used for determining the confidence. Such an algorithm may be converted to a computer program comprising a set of executable instructions, which may be executed by the labeling module 60. The labeling module 60 may determine whether the determined confidence satisfies a predetermined threshold. Based on such a determination, for example, when the confidence satisfies the predetermined threshold, the labeling module 60 may label the unlabeled event. Alternatively, the labeling module 60 may activate the learning module 70 for user input regarding the relationship between the selected event and the reported events. For example, when the learning module 70 is activated the display 74 may request that the user 80 approve the selected event or make an alternative selection. In such an instance, the labeling module 60 may label the selected event with a classifier based upon the user input. This may include that the labeling module 60 labels the selected event in the computer-searchable database 52. It is also contemplated that the labeling module 60 may be self-learning and may include example based evidentiary reasoning that may capture the input from the user 80 in a way that the system 50 can build and learn from the user interaction.

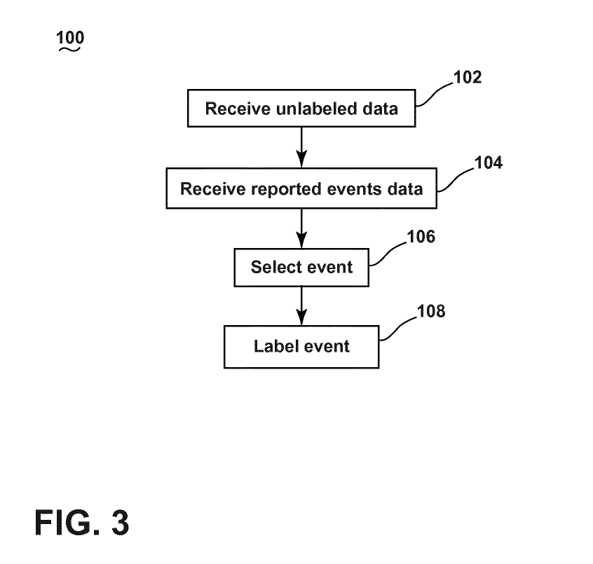

In accordance with an embodiment of the innovation, FIG. 3 illustrates a method 100, which may be used for categorizing events. The method 100 begins at 102 by, the labeling module 60, receiving data related to one or more systems or assets from the one or more systems or assets. Such data may be understood to be unlabeled data. The data may take any suitable form including that the received data may include at least one data table. Such an unlabeled data table may be obtained by performing feature extraction algorithms on a data stream.

At 104, the labeling module 60 may receive data regarding reported events. The reported events data may also take any suitable form including that the reported events data may include at least one data table. The reported events may include events that have been physically observed such as known faults that occurred on assets, with the date on which they were detected and their nature, a list of known economical events, or a list of confirmed medical diagnostics. In the instance where the faults relate to an asset, the reported events may include a log of maintenance records.

At 106, the labeling module 60 may select an event from the unlabeled data based on the data regarding the reported events. Such a selection may be achieved in various ways using various algorithms or computer programs. For example, the labeling module 60 may determine a most important event in the unlabeled data. In such an instance the labeling module 60 may ignore random fluctuation events and the labeling module 60 may use a simple algorithm to select the most important event in the recent history of the asset. This may require defining a way of measuring the significance of an event. For example, if shifts in parameters are considered, the importance of shifts can be measure by their size normalized by the noise level. The importance of an event may be estimated by calculating the sum of the normalized sizes of shifts in all parameters. This selection method may incorrectly select an event if there is a large step in an unrelated parameter.

The labeling module 60 may thus alternatively base the selection on one most important event in one or more relevant parameters. This may be achieved, for each event classification, by assigning weights to all parameters describing how relevant they are for the given event classification. For example, for an event classification of an oil leak, a weight of 90% may be assigned to oil pressure and 10% to sound level if they know that an oil leak always causes a drop in oil pressure and sometimes causes a specific noise. No weight may be assigned to vibration as vibration may be determined to be not relevant to an oil leak. In such an instance, a weighted sum of the normalized sizes may be used to determine the most important event observed in the relevant parameters for the event classification.

Further still, the labeling module 60 may use predefined classifiers to identify, in a list of data events, which event is, probabilistically, the most likely to be related to a reported event. This may require that models have been built for the classification of such events. Regardless of how the event is selected from, the unlabeled data, at 108, the labeling module 60 may label the selected event based on the data regarding the reported events. More specifically, the selected event may be tied to the reported event.

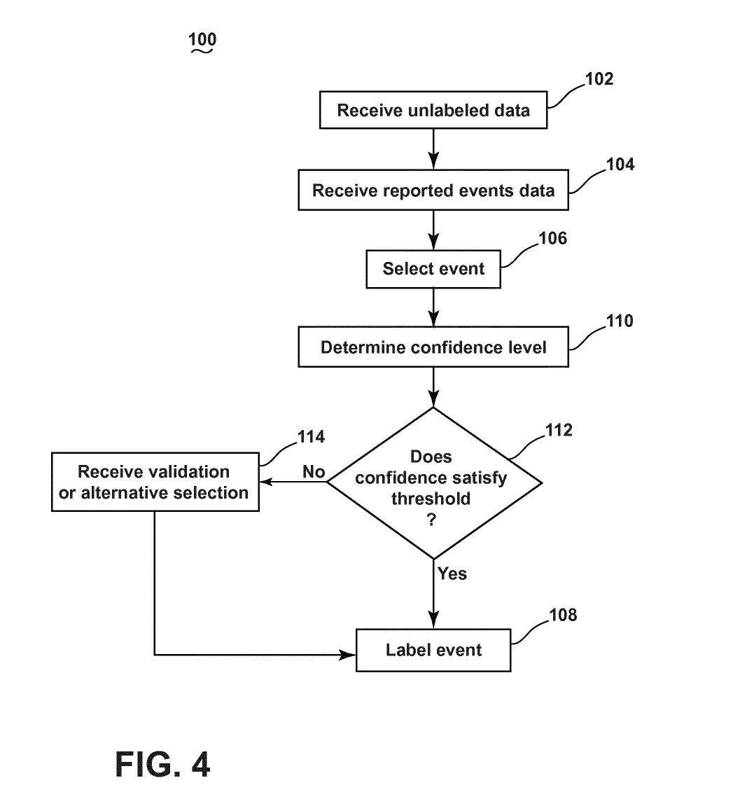

It will be understood that the method of categorizing and labeling events is flexible and the method 100 is illustrated merely for illustrative purposes. For example, the sequence of steps depicted is for illustrative purposes only, and is not meant to limit the method 100 in any way, as it is understood that the steps may proceed in a different logical order or additional or intervening steps may be included without detracting from embodiments of the innovation. By way of non-limiting example, the receiving of the data at 102 and 104 may occur in any order and the data may be received simultaneously. Further, the method 100 may also include determining a confidence level in the selection as illustrated in FIG. 4 at 110. The confidence level in the selection may be determined in any suitable manner including that an algorithm may be used for determining the confidence. A confidence level may also be determined by counting how many data events are reported in a period of time before the reported events. If there over a predetermined number, then the confidence in the selection may be low. If there is less than a predetermined number, then the confidence may be high. Alternatively, a magnitude of the selected event may be compared to a magnitude of another event or a magnitude of other events. If the ratio is large (i.e the selected event is much more significant than any other event), then the confidence may be high. If the ratio is close to 1 (i.e. the selected event is similar in size to one or more other events), then the confidence is low. It may then be determined if the confidence level satisfies a threshold at 112. The term “satisfies” the threshold is used herein to mean that the variation comparison satisfies the predetermined threshold, such as being equal to, less than, or greater than the threshold value. It will be understood that such a determination may easily be altered to be satisfied by a positive/negative comparison or a true/false comparison. For example, a less than threshold value can easily be satisfied by applying a greater than test when the data is numerically inverted.

If the threshold is satisfied, the method may move on to label the event at 108 as described above. If the threshold is determined to not be satisfied, then the method may require validation of the selection or an alternative selection to be made by a user at 114. This may be done by the learning module 70 as previously described. Once the validation or alternative selection is received, the method may move on to label the event at 108.

Specific examples may prove useful and thus the remainder of this description will pertain to data received regarding an aircraft. The labeling module 60 may receive the unlabeled dataset, which may take any form including that of an unlabeled data events table. A generic example of an unlabeled data events table is shown in Table 1 below.

TABLE 1
Unlabeled Data Events Table

| Data | Asset | Data Event | Event | Event | Event |
|---|---|---|---|---|---|
| Event ID | ID | Date | Feature 1 | Feature 2 | Feature 3 |
| 1 | 41 | May 1, 2012 | 4.234 | 3 | false |
| 2 | 12 | Mar. 5, 2013 | 12.651 | 1 | true |
| 3 | 12 | Jun. 6, 2012 | 3.127 | 2 | true |
| 4 | 31 | Jan. 13, 2011 | 6.845 | 1 | true |
| 5 | 121 | Oct. 21, 2011 | 9.124 | 3 | false |

The table may include a variety of information that may include raw data, data obtained by performing feature extraction on the initial data, asset IDs, the date of the data event, and various features or characteristics. Table 2, below, shows a table that is specific to a fleet of aircraft engines.

TABLE 2
Unlabeled Data Event Table

| Data | | | | Shift in | Oil |
|---|---|---|---|---|---|
| Event | Engine | | Shift in | Vibration | Valve |
| ID | ID | Shift Date | Pressure | Level | Closed |
| 1 | 41 | May 1, 2012 | 102 | 3 | false |
| 2 | 12 | Mar. 5, 2012 | 98 | 1 | true |
| 3 | 12 | Jun. 6, 2012 | 50 | 2 | true |
| 4 | 31 | Jan. 13, 2011 | 112 | 1 | true |
| 5 | 121 | Oct. 21, 2011 | 23 | 3 | false |

As illustrated, Table 2 provides information regarding a number of events related to a fleet of engines. Features have been obtained from the various initial engine data and five unlabeled data events have been shown along with various information regarding each event. More specifically, shifts in pressure, shifts in vibration level, information related to an oil valve, and dates of the selected shifts have been included.

Furthermore, the labeling module 60 may receive the reported events data. Again, such data may take any form including that of a table as shown in Table 3 below.

TABLE 3
Reported Events Table

| Reported | Asset | Reported | |
|---|---|---|---|
| Event ID | ID | Event Date | Event Classification |
| 1 | 10 | Jun. 1, 2012 | Oil Leak |
| 2 | 12 | Mar. 8, 2012 | Crack in Turbine |
| 3 | 30 | Jan. 3, 2011 | Maintenance/Cleaning |
| 4 | 31 | Jan. 24, 2011 | Oil Leak |

According to the system and methods described above, each event in the reported events table may be processed in turn. More specifically, for each event, algorithms may be used to determine, from the list of unlabeled events, which one is the most likely to be related to a reported event. For example, an algorithm to determine a most recent event may be used. In such an instance, if a reported event of type T occurred on date D on asset number A, then the last data event that occurred on the asset A before date D is selected to be labeled as T. This relies on the assumption that no data events occurred between the day the fault happened and the day it was discovered. This is not always the case, which is why alternative algorithms and methods such as those described above may be used.

Thus, from the two datasets, the selected event may be classified. A labeled data event table may be created based upon such classifications. In such a labeled data table, a label or classification has been assigned to the data events when they were found to match in terms of asset id, date, and ideally, features with a reported event. The label or classification indicates the nature of the matching reported event. Events in the unlabeled data set may be thus be categorized. The classified events may also take any form, including that of a table as shown below in Table 4.

TABLE 4
Labeled Data Events Table

| Data | Event | | | Event | Event | Event |
|---|---|---|---|---|---|---|
| Event | Classi- | Asset | Data Event | Feature | Feature | Feature |
| ID | fication | ID | Date | 1 | 2 | 3 |
| 1 | Other | 41 | 1 May 2012 | 4.234 | 3 | false |
| 2 | Crack in | 12 | 5 Mar. 2012 | 12.651 | 1 | true |
| | Turbine | | | | | |
| 3 | Other | 12 | 6 Jun. 2012 | 3.127 | 2 | true |
| 4 | Oil Leak | 31 | 13 Jan. 2011 | 6.845 | 1 | true |
| 5 | Other | 121 | 21 Oct. 2011 | 9.124 | 3 | false |

Another example may prove useful. Table 5 illustrates a list of unlabeled data events where there have been shifts in performance parameters for an engine.

TABLE 5
Unlabeled Data Events Table

| Data | | Data | Oil | Noise | Vibration |
|---|---|---|---|---|---|
| Event | Asset | Event | Pressure | Level | Level |
| ID | ID | Date | Shift | Shift | Shift |
| 1 | 10 | Jun. 8, 2012 | 1 | −0.01 | 0.1 |
| 2 | 10 | Jun. 10, 2012 | −12 | 0.2 | −0.3 |
| 3 | 10 | Jun. 12, 2012 | −1 | −1.3 | −4.2 |
| 4 | 10 | Jun. 17, 2012 | 1 | 0.02 | −0.3 |

Table 6 illustrates a portion of a reported events table having one row of the list of reported events.

TABLE 6
Partial Reported Events Table

| Reported | Asset | Reported | Event |
|---|---|---|---|
| Event ID | ID | Event Date | Classification |
| . . . | . . . | . . . | . . . |
| 75 | 10 | Jun. 18, 2012 | Oil Leak |
| . . . | . . . | . . . | . . . |

In the reported events information, an oil leak was detected in asset number 10 on Jun. 18, 2012. In looking for a related event in the unlabeled data events table the labeling module 60 may take into account that when an oil leak occurs, the oil pressure usually drops, but vibration is not affected. If the simple algorithm described above where the last data event that occurred on the asset A before date D is selected to be labeled as T is used the classification ‘oil leak’ will be associated with the latest data event that occurred in the asset before the discovery date. In the above example, this is event ID 4, which occurred on June 17. This may be an incorrect selection, as event ID 4 seems to be a minor event possibly due to random fluctuations in the data. Selecting event ID 3 would also be incorrect, as it seems to be an event related to vibration, and not the oil leak.

If the labeling module 60 were to detect a last data event before June 18 which is relevant to one of one of the classification parameters such as by assigning weights to all parameters describing how relevant they are for the given event classification then event ID 2 would be selected. Event ID 2 must have been due to the oil leak as it is the only event featuring a large drop in oil pressure and the labeling module 60 may utilize an algorithm that is weighted accordingly.

In some cases, algorithms may prove unable to identify correctly the relevant data event or they may select an event with a high level of uncertainty. This can be due to several data events being found in the asset near the date of the observed event, with similar significance or probabilities. If the confidence in the selection is less than a predetermined threshold, the selection may be validated by the user. This may be done by a user interface illustrating information based on the unlabeled data. Such graphical illustrations may make it easier for the user to determine the related event in a quick and efficient manner instead of requiring the user to look manually through the data.

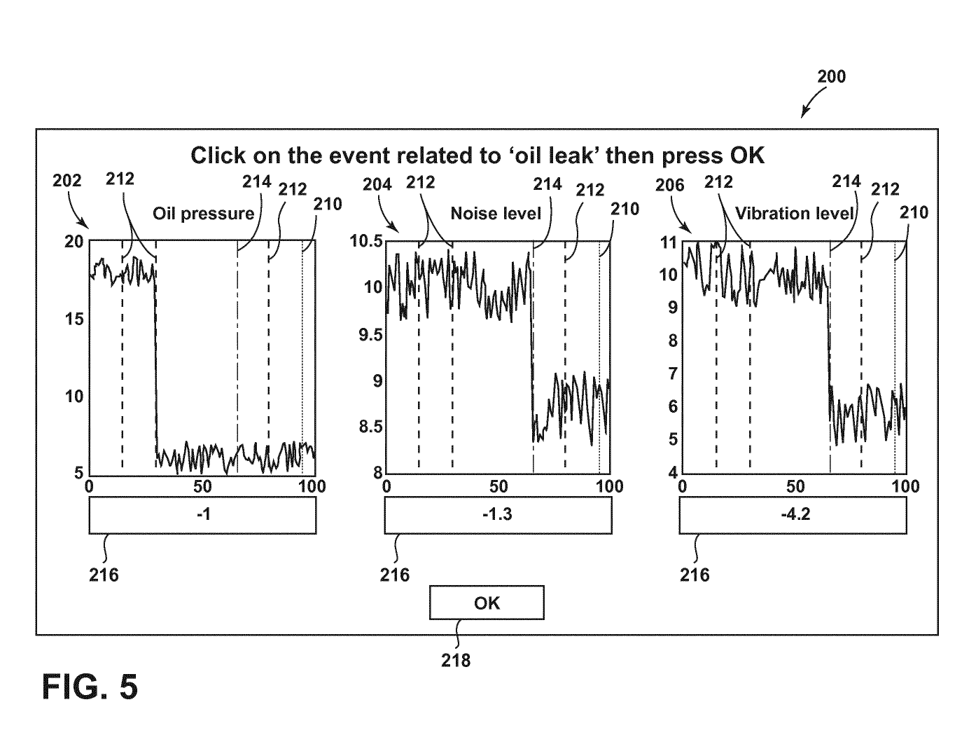

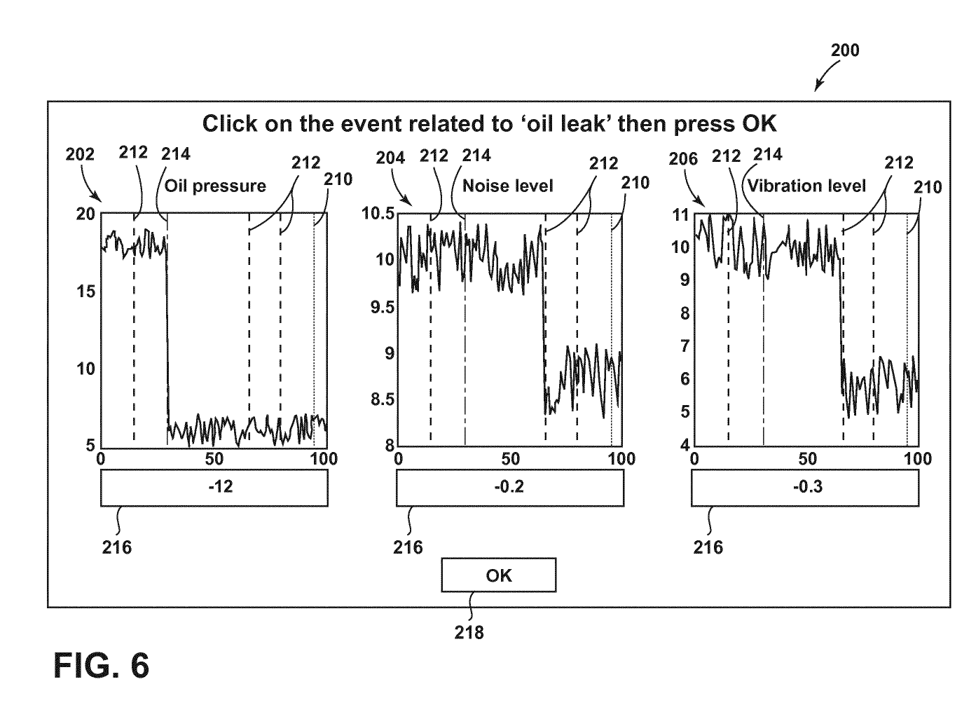

By way of example, the labeling module may have selected event ID 3 as the oil leak, but with low confidence. A window 200, as shown in FIG. 5, may be displayed on the display 74. The widow 200 illustrates several plots of information related to the oil pressure 202, the noise level 204, and the vibration level 206. On each of these plots of information 202-206, the date of the reported event is shown with the line 210, data events in the recent history of the asset are shown with lines 212, and the currently selected event is shown with line 214. Features of the selected event may also be shown, including the shift sizes 216. The lines 210-214 may be included to draw a user's attention and aid a user in judging the correct correlation in the plots 202-206. If the user agrees with the event selection (i.e. event ID 3 is the oil leak), the user merely has to click the ‘OK’ at 218. In the above example, the user may determine that the selection is incorrect and the correct event is the event ID 2, which features a drop in oil pressure. The user may then click on the correct event, so that it becomes the selected event, as shown in FIG. 6, and click ‘OK’ at 218, which will cause the label ‘oil leak’ to be assigned to event ID 2.

Beneficial effects of the above described embodiments include that large amounts of data gathered from a complex system may automatically or semi-automatically be assessed by a system and unlabeled events may be categorized. Further, in the event that there is a low confidence in such a selection the information may be easily assessed by a user as the relevant data may be quickly and efficiently conveyed to a user.

Labeling datasets manually may be very time-consuming and performing such labeling automatically is not an easy task and may lead to mislabeled datasets, which may then produce incorrect models. The above described embodiments provide a variety of benefits including that data sets may be automatically or semi-automatically labeled in an accurate manner. The above described embodiments may be used to determine probabilistically the nature of events detected in the data and may rapidly provide for the categorization of such events giving a competitive advantage.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the innovation, including the best mode, and also to enable any person skilled in the art to practice the innovation, including making and using any devices or systems and performing any incorporated methods. The patentable scope of the innovation is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of categorizing events found in data, comprising:
receiving, by a labeling module, data related to one or more systems or assets from the one or more systems or assets;
receiving, by the labeling module, data regarding reported events;
selecting, by the labeling module, an event from the data related to the one or more systems or assets based on the data regarding the reported events; and
labeling the selected event, by the labeling module, based on the data regarding the reported events.

2. The method of claim 1, further comprising determining, by the labeling module, a confidence level in the selection.

3. The method of claim 2, further comprising determining if the confidence satisfies a predetermined threshold.

4. The method of claim 3 wherein the labeling the selected event occurs when it is determined the confidence satisfies the predetermined threshold.

5. The method of claim 3, further comprising obtaining, by a learning module, a user validation of the selection when it is determined the confidence does not satisfy the predetermined threshold.

6. The method of claim 1, wherein the received data related to the one or more systems or assets comprises at least one data table obtained by performing feature extraction algorithms on the data stream.

7. The method of claim 1, wherein the received data related to the reported events comprises at least one data table of events that have been observed.

8. A system for categorizing events found in data, comprising:
a computer-searchable database containing unlabeled data related to one or more systems or assets and data related to reported events; and
a labeling module in communication with the computer-searchable database and configured to: receive data from the computer-searchable database, select from the unlabeled data an event related to the reported events, and label the selected event based thereon.

9. The system of claim 8, wherein the labeling module is further configured to determine a confidence in a relationship between the selected event and the reported events.

10. The system of claim 9, wherein the labeling module is configured to determine whether the determined confidence satisfies a predetermined threshold.

11. The system of claim 10, further comprising a learning module operably coupled to the labeling module and configured to receive user input regarding the relationship between the selected event and the data related to reported events.

12. The system of claim 11, wherein the labeling module activates the learning module for user input when the confidence does not satisfy the predetermined threshold.

13. The system of claim 12, wherein the labeling module labels the selected event in the computer-searchable database with a classifier based upon the user input.

14. The system of claim 10, wherein the labeling module labels the selected event in the computer-searchable database with a classifier when the confidence satisfies the predetermined threshold.

15. The system of claim 8, wherein the labeling module further comprises an algorithm for determining the confidence.

16. The method of claim 4, further comprising obtaining, by a learning module, a user validation of the selection when it is determined the confidence does not satisfy the predetermined threshold.

17. The system claim 11, wherein the labeling module labels the selected event in the computer-searchable database with a classifier when the confidence satisfies the predetermined threshold.

18. The system claim 12, wherein the labeling module labels the selected event in the computer-searchable database with a classifier when the confidence satisfies the predetermined threshold.

19. The system claim 13, wherein the labeling module labels the selected event in the computer-searchable database with a classifier when the confidence satisfies the predetermined threshold.

20. The system of claim 9, wherein the labeling module further comprises an algorithm for determining the confidence.
